(19) United States
(12) Patent Application Publication
(10) Pub. No.: US 2026/0115714 A1
(43) Pub. Date: Apr. 30, 2026

(54) Microfluidic Sample Devices

(71) Applicant: ibidi GmbH, Gräfelfing (DE)

(72) Inventors: Elias Horn, Feucht (DE); Roman Zantl, Gräfelfing (DE)

(21) Appl. No.: 19/368,178

(22) Filed: Oct. 24, 2025

(30) Foreign Application Priority Data
Oct. 30, 2024 (EP) 24209818.4

(51) Int. Cl. B01L 3/00

(52) U.S. Cl. CPC B01L 3/502707; B01L 2200/02; B01L 2300/123

(57) ABSTRACT

A microfluidic sample device includes a first container having a first opening in a first bottom plane on an underside of the first container, and a second container having a second opening in a second bottom plane on an underside of the second container. The first container is at least partially arranged inside the second container. The first container is connected to the second container. The first bottom plane is offset upwardly relative to the second bottom plane.

No new matter is added via these amendments.

### RELATED APPLICATIONS

This application claims the benefit of European Patent Application No. 24209818.4, filed Oct. 30, 2024, the entire contents of which is hereby incorporated by reference.

### TECHNICAL FIELD

The present disclosure relates to microfluidic sample devices and to a method for manufacturing thereof.

### BACKGROUND

In the field of cell and tissue culture models, biological interfaces are usually created using porous and permeable membranes. These membranes stabilize the cells in the culture and allow different fluids to be used on both sides of the membrane. For this purpose, an insert with a membrane stretched over it is suspended in a container of a cell culture plate or in a Petri dish. The insert itself is filled, as is the container, so that the membrane separates the two liquids. If cells are cultivated on this membrane, they can be cultivated and examined at this interface. Both sides of the membrane can be filled with different liquids or concentrations.

These membrane inserts can simulate biological interfaces, such as the transition areas between tissues in the human body that are clearly separated from one another. Typical cell model systems that form interfaces and are distinct in their natural environment include endothelial cells, epithelial cells, and kidney cells.

Commercially available membrane inserts include Corning®Transwell®, Nunc™ polycarbonate cell culture inserts, and ThinCert® cell culture inserts (Greiner Bio-One), with membranes consisting of various thermoplastic polymer materials such as polyester and polycarbonate. Pore sizes ranging from approx. 0.5 μm to approx. 12 μm are used.

Such conventional membrane inserts have the disadvantage that the biological interface is not reproduced close to its natural state and the membrane material hinders microscopic examination due to high autofluorescence, poor transmission, and scattering effects. There is therefore a need for a microfluidic sample device that allows microscopy to be performed at a biological interface close to the natural state.

### SUMMARY

Provided herein is a microfluidic sample device for separating parts of the sample or of a medium surrounding the sample.

### BRIEF DESCRIPTION OF THE DRAWINGS

Embodiments of the present disclosure are explained in more detail with reference to the following exemplary Figures.

FIG. 1 schematically shows an embodiment of a sample device in a sectional view,

FIG. 2 schematically shows a further embodiment of a sample device in a top view,

FIG. 3 schematically shows the embodiment of the sample device of FIG. 2 in a sectional view along line A-A,

FIG. 4 schematically shows a further embodiment of a sample device in a sectional view.

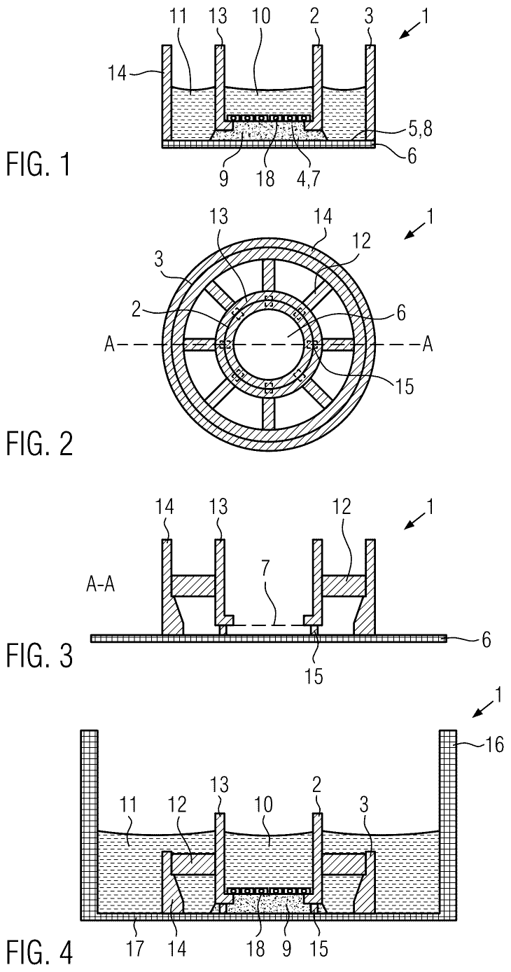

FIGS. 1 to 4 illustrate the schematic structure of three different embodiments of a sample device 1.

### DETAILED DESCRIPTION

The present disclosure provides a microfluidic sample device comprising a first container having a first opening in a first bottom plane on its underside, and a second container having a second opening in a second bottom plane on its underside, wherein the first container is at least partially arranged inside the second container, wherein the first container is connected to the second container, and wherein the first bottom plane is offset upwardly relative to the second bottom plane.

The two containers and the offset bottom planes allow parts of the sample or the medium surrounding the sample to be separated.

All location information such as “underside,” “inside,” “top,” “lateral”, etc. refers to the intended use of the sample device.

The first container can be fixed relative to the second container. This means that the first container has a fixed position relative to the second container or occupies a fixed relative position with respect to the second container.

The fact that the first bottom plane is offset upwardly relative to the second bottom plane means that the underside of the first container is offset upwardly relative to the underside of the second container. In other words, when used as intended, the second container ends below the first container.

The sample device may comprise a bottom element that closes the second opening.

By the bottom element, the second container is closed downwardly, preventing loss of liquid.

The bottom element may form a bottom of the second container. The bottom element itself may be impermeable to liquid.

The sample device may comprise a third container having a closed bottom, wherein the first container and the second container may be arranged at least partially inside the third container.

The third container prevents liquid from leaking out of the first and/or second containers. The third container serves as a reservoir for liquid.

No liquid can escape from the closed bottom.

The third container can form a bottom for the second container.

The third container can be configured as a recess in accordance with microtiter plate standards (e.g., ANSI standard “ANSI SLAS 4-2004 (R2012) (formerly recognized as ANSI/SBS 4-2004)”) or Petri dishes. The third container can be the size of a microscope slide (e.g., according to DIN ISO 8037-1:2003-05).

One, six, twelve, 24, 48, 96, 384, and/or 1536 of the aforementioned first and second containers can be formed in a microtiter plate, a Petri dish, and/or on a slide.

The first container and/or the second container each comprise a side wall.

The first container may end above the second container. In particular, the side wall of the first container may end above the side wall of the second container.

The present disclosure further provides a microfluidic sample device comprising a first container having a first opening in a first bottom plane on its underside, and a second container having a closed bottom, wherein the first container is at least partially arranged inside the second container, wherein the first container is connected to the second container, and wherein the first bottom plane is offset upwardly relative to the bottom.

The two containers and the offset bottom planes allow parts of the sample or the medium surrounding the sample to be separated.

No liquid can escape from the closed bottom.

The bottom element or the bottom of the sample devices described above may comprise or consist of a transparent material.

The transparent material of the bottom element or the bottom allows microscopy through the bottom element or the bottom.

The transparent material is transparent in a wavelength range suitable for microscopy, in particular in a visible wavelength range of light.

The transparent material may be glass, cyclo-olefin copolymer (COC), cyclo-olefin polymer (COP), polymethyl methacrylate (PMMA), polycarbonate (PC), polyethylene (PE) or polystyrene (PS). The bottom element may comprise or consist of a plastic film. The plastic film can have a thickness in the range of 2 μm to 0.5 mm, in particular a thickness of approximately 170 μm. The plastic film can be a plastic film without birefringence and/or with an intrinsic fluorescence that is essentially the same as the intrinsic fluorescence of a conventional cover glass.

The bottom element or the bottom of the sample devices described above can have a thickness of at least 25 μm, in particular at least 100 μm, in particular at least 500 μm, and/or at most 2 mm, in particular at most 1.5 mm, in particular at most 1 mm. Each of the specified lower limits can be combined with each of the specified upper limits.

A bottom element or a bottom of corresponding thickness makes it possible to minimize the influence of the bottom element or the bottom on microscopy, in particular with regard to absorption and scattering effects, through the bottom element or the bottom, while at the same time ensuring stability.

The sample devices described above may comprise a strut connecting the first container laterally to the second container.

The insertion of the strut improves the stability of the sample device.

The strut of the sample devices described above may be arranged above the first bottom plane.

The strut above the first bottom plane allows liquid to reach the first container from below, as the space between the second bottom plane and the first bottom plane is not blocked by the strut.

The sample devices described above can be formed in one piece or in several pieces. For example, the first container, the second container, and the strut can consist of one piece, and the bottom element can be a separate piece. The piece of the first container, the second container, and the strut can be produced by injection molding.

One of the sample devices described above may comprise a spacer attached to the underside of the first container, wherein the spacer extends to the second bottom plane or to the bottom.

A sample device with a spacer prevents the first container from slipping in the vertical direction.

The spacer may only extend around part of a lower edge of the first container.

The spacer may be formed integrally with the first container.

The first container can be connected to or attached to the second container via an additional element. The additional element can be the strut or the spacer and the bottom element or the bottom. The first container can be connected to the bottom element or the bottom via the spacer. The first container can be connected to the second container via the bottom element or the bottom, in particular a plate.

The second container and/or the spacer of the sample devices described above may have a sticky surface on their underside.

A bottom element can be attached using the sticky surface.

In this context, “sticky” means that stickiness occurs at room temperature, in particular between 20 and 25° C., and at 30-40% relative humidity. In particular, stickiness should occur when the second container is connected to the bottom element. The sticky connection should be 100% liquid-tight. The sticky surface can be permanently sticky and/or non-hardening. This allows the second container to be connected to the bottom element multiple times, at least on dry surfaces. The sticky surface can include or consist of a thermoplastic or silicone.

The surface may itself be sticky or have a sticky coating.

One of the sample devices described above may further comprise a hydrogel that closes the first opening.

The hydrogel creates an interface between the interior of the first container and the interior of the second container, in particular the interior of the first container located outside the second container.

The hydrogel may have an elasticity modulus in a range of 1 to 10 kPa. The hydrogel may be Matrigel, collagen, fibrin, polyacrylamide, GelMA, agarose, or a derivative thereof. Gel polymerization of the hydrogel may be effected by changing the pH of the hydrogel, changing the temperature, or exposing it to UV light.

The hydrogel can extend to the second bottom plane or to the bottom element or bottom. The hydrogel can have a thickness of at least 0.05 mm, in particular at least 0.1 mm, in particular at least 0.5 mm, in particular at least 1 mm, and/or at most 5 mm, in particular at most 4.5 mm, in particular at most 4 mm, in particular at most 3 mm. Each of the specified lower limits can be combined with each of the specified upper limits.

Liquid can pass through the first opening which is closed by the hydrogel by diffusion or flow due to a pressure difference.

The first container of one of the sample devices described above can have a volume of at least 20 μl, in particular at least 50 μl, in particular at least 100 μl, in particular at least 500 μl, and/or at most 2000 μl, in particular at most 1500 μl, in particular at most 1000 μl. Each of the specified lower limits can be combined with each of the specified upper limits.

With a corresponding volume, the first container can be used in a microfluidic setup.

The first container may have a circular, elliptical, or rectangular outline. The first container may be cylindrical. The volume of the first container is the volume of the interior of the first container. The first container may have an outer diameter of at least 2 mm, in particular at least 3 mm, in particular at least 4 mm, in particular approximately 4.5 mm, and/or at most 15 mm, in particular at most 10 mm, in particular at most 5 mm. Each of the specified lower limits may be combined with each of the specified upper limits.

The second container can have a volume of at least 20 μl, in particular at least 50 μl, in particular at least 100 μl, in particular at least 500 μl, and/or at most 2000 μl, in particular at most 1500 μl, in particular at most 1000 μl. Each of the specified lower limits can be combined with each of the specified upper limits.

The second container may have a circular, elliptical, or rectangular outline. The second container may be cylindrical. The volume of the second container is the volume of the interior of the second container. The second container can have an outer diameter of at least 4 mm, in particular at least 5 mm, in particular at least 10 mm, in particular approximately 12 mm, and/or at most 50 mm, in particular at most 25 mm, in particular at most 15 mm. Each of the specified lower limits can be combined with each of the specified upper limits.

The first opening of one of the sample devices described above may have a diameter of at least 0.5 mm, in particular at least 2 mm, in particular approximately 3 mm, and/or at most 8 mm, in particular at most 6 mm, in particular at most 4 mm. Each of the specified lower limits may be combined with each of the specified upper limits.

A suitable diameter of the first opening allows microscopy in the first opening without interference from the first container.

One of the sample devices described above may comprise or consist of a thermoplastic polymer and/or an elastomer.

With these materials, the sample device can be easily manufactured using known manufacturing methods under the influence of heat.

In particular, the first container, the second container and the strut may comprise or consist of the thermoplastic polymer and/or the elastomer. The sample device may be manufactured by injection molding, deep drawing or 3D printing.

The present disclosure provides a method for manufacturing a microfluidic examination device, in particular the sample device described herein. The operations for manufacturing a microfluidic examination device comprise arranging an insert comprising a first container, which has a first opening in a first bottom plane on its underside, and a second container having a second opening in a second bottom plane on its underside, on a bottom element, wherein the first container is at least partially arranged inside the second container, wherein the first bottom plane is offset upwardly relative to the second bottom plane. The operations further include introducing a hydrogel into the interior of the first container so that the first opening of the first container is closed.

Parts of a sample or of a medium surrounding the sample can be separated.

After being introduced into the interior of the first container, the hydrogel can have a thickness of at least 0.05 mm, in particular at least 0.1 mm, in particular at least 0.5 mm, in particular at least 1 mm, and/or at most 5 mm, in particular at most 4.5 mm, in particular at most 4 mm, in particular at most 3 mm. Each of the specified lower limits can be combined with each of the specified upper limits.

Using diffusion or flow due to a pressure difference, liquid can pass through the first opening closed by the hydrogel.

The method can also be carried out using the sample device with a second container having a closed bottom, in which case it simply comprises the operation of introducing a hydrogel into the interior of the first container so that the first opening of the first container is closed.

Referring now to the figures, the sample device 1 in FIG. 1 comprises a first container 2 which is arranged inside a second container 3. The first container 2 has a first opening 4 on its underside. A second opening 5 on the underside of the second container 3 is closed in a liquid-tight manner by a transparent bottom element 6, for example a polycarbonate plate. The bottom element 6 can be stuck to the second container 3, for example via a sticky surface on the underside of the second container 3.

A first bottom plane 7 of the first container 2 is arranged offset upwardly relative to a second bottom plane 8 of the second container 3. This creates an intermediate space into which a hydrogel 9 is introduced. The hydrogel 9 closes the first opening 4 and extends up to the bottom element 6. The hydrogel 9 has a thickness of approx. 1 mm in the direction of the first opening 4 up to the bottom element 6.

When the first container 2 and the second container 3 are filled with a first liquid 10 and a second liquid 11, respectively, as shown in FIG. 1, the liquids in the containers communicate via the hydrogel 9.

When the fill levels of the first and second containers 3 are identical, the liquids exchange in a diffusive manner. The system is then pressure-free. No flow occurs through the hydrogel 9. If the first liquid 10 and the second liquid 11 contain different concentrations of a reagent, a concentration gradient forms across the hydrogel 9 or across a corresponding interface.

If the fill levels of the first and second containers 3 are different, a pressure difference arises and a compensating flow takes place through the hydrogel 9. This pressure-driven flow can be used as a simulation of an interstitial flow through a tissue.

In any case, an interface in contact with both liquids is formed on the surface of the hydrogel 9. After biological cells 18 are introduced into the first container 2, these biological cells 18 can be observed at the interface. In particular, inverse microscopy is possible through the transparent bottom element 6.

The embodiment of FIG. 1 represents a microfluidic examination device.

FIG. 2 shows, corresponding to FIG. 1, a sample device 1 with a first container 2, a second container 3 and a bottom element 6.

A cross-section of the first container 2 is circular. The first container 2 is coaxially located in the second container 3, which also has a circular cross-section. A side wall 13 of the first container 2 is connected to a side wall 14 of the second container 3 by lateral struts 12. The struts 12 hold the first container 2 laterally in its coaxial position relative to the second container 3. The struts 12 are only formed at certain points, for example eight struts 12 distributed evenly around the circumference of the geometry, and do not extend around the entire circumference of the circular geometry. In addition, the struts 12 are arranged offset upward relative to the bottom element 6 and the first bottom plane 7 (see also FIG. 3 for clarification). This ensures that a second liquid 11 can be filled from above into the space between the first container 2 and the second container 3 and reach the bottom element 6 without being significantly impeded by the struts 12.

In addition, the first container 2 is held in its vertical position relative to the bottom element 6 by spacers 15 in addition to the struts 12. The spacers 15 are also only formed at certain points. For example, in a top view, the spacers 15 are formed in radial extensions of struts 12 toward the center axis of the second container 3. This ensures that the second liquid 11 reaches a first opening 4 in a first bottom plane 7 of the first container 2 or a hydrogel 9 that closes the first opening 4 from below.

FIG. 3 shows an example of the struts 12 and spacers 15 in a cross-sectional view along line A-A in FIG. 2. The first container 2, the second container 3, the struts 12, and the spacers 15 can be formed together in one piece.

FIG. 4 shows, corresponding to FIGS. 2 and 3, a sample device 1 comprising a first container 2, a second container 3, struts 12, and spacers 15.

In addition, a third container 16 with a closed bottom 17 is provided, inside which the first and second containers 3 are arranged. A sticky underside of the second container 3 and a sticky underside of the spacers 15 can be attached to the bottom 17 of the third container 16.

In addition, further first containers 2 and second containers 3 may be arranged inside the third container 16 as described above.

A side wall 13 of the first container 2 ends above a side wall 14 of the second container 3. This allows the space between the first container 2 and the second container 3 to be filled with the same second liquid 11 as the space between the second container 3 and the third container 16, but not the space inside the first container 2, up to a common filling level. This increases the volume of the second liquid 11. This second liquid 11 comes into contact with biological cells 18 at the interface with a first liquid 10 in the first container 2 via the hydrogel 9.

When used with multiple first containers 2 and second containers 3 in a third container 16, the throughput can be parallelized. The second liquid 11 then only needs to be added at one point to fill all spaces between the first containers 2 and second containers 3.

Furthermore, a conventional microtiter plate or Petri dish can provide, for example, 1, 6, 12, 24, 48, 96, 384, or 1536 recesses as third containers 16. The third container can be the size of a microscope slide.

Individual elements of the embodiments described above can be combined with one another. For example, the struts 12 and spacers 15 of FIGS. 2, 3, and 4 can also be provided in the embodiment of FIG. 1. Furthermore, the third container 16 of FIG. 4 can be exchanged with a bottom element 6 of FIGS. 1, 2, and 3, and vice versa.

It is to be understood that the above description is intended to be illustrative, and not restrictive. Other embodiments will be apparent upon reading and understanding the above description. Although embodiments of the present disclosure have been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

1. A microfluidic sample device comprising:
a first container having a first opening in a first bottom plane on an underside of the first container, and
a second container having a second opening in a second bottom plane on an underside of the second container,
wherein the first container is at least partially arranged inside the second container,
wherein the first container is connected to the second container, and
wherein the first bottom plane is offset upwardly relative to the second bottom plane.

2. The microfluidic sample device according to claim 1, further comprising:
a bottom element which closes the second opening.

3. The microfluidic sample device according to claim 1, further comprising:
a third container having a closed bottom,
wherein the first container and the second container are at least partially arranged inside the third container.

4. (canceled)

5. The microfluidic sample device according to claim 2,
wherein the bottom element comprises a transparent material.

6. The microfluidic sample device according to claim 2,
wherein the bottom element has a thickness of at least 25 μm and less than 2 mm.

7. The microfluidic sample device according to claim 1, further comprising:
a strut to laterally connect the first container to the second container.

8. The microfluidic sample device according to claim 7,
wherein the strut is arranged above the first bottom plane.

9. The microfluidic sample device according to claim 1, further comprising:
a spacer attached to the underside of the first container,
wherein the spacer extends to the second bottom plane.

10. The microfluidic sample device according to claim 9,
wherein the second container and/or the spacer have a sticky surface on an underside.

11. The microfluidic sample device according to claim 1, further comprising:
a hydrogel that closes the first opening.

12. The microfluidic sample device according to claim 1,
wherein the first container has a volume of at least 20 μl and less than 2000 μl.

13. The microfluidic sample device according to claim 1,
wherein the first opening has a diameter of at least 2 mm.

14. The microfluidic sample device according to claim 1,
wherein the microfluidic sample device comprises at least one of a thermoplastic polymer or an elastomer.

15. A method for manufacturing a microfluidic examination device comprising:
arranging an insert comprising a first container which has a first opening in a first bottom plane on an underside of the first container, and a second container which has a second opening in a second bottom plane on an underside of the second container, on a bottom element, wherein the first container is at least partially arranged inside the second container, wherein the first bottom plane is offset upwardly relative to the second bottom plane,
inserting a hydrogel into an interior of the first container so that the first opening of the first container is closed.

16. A microfluidic sample device comprising:
a first container having a first opening in a first bottom plane on an underside of the first container, and
a second container having a closed bottom,
wherein the first container is at least partially arranged inside the second container,
wherein the first container is connected to the second container, and
wherein the first bottom plane is offset upwardly relative to the closed bottom.

17. The microfluidic sample device according to claim 16, wherein the closed bottom comprises a transparent material.

18. The microfluidic sample device according to claim 16, further comprising:
a spacer attached to the underside of the first container,
wherein the spacer extends to the closed bottom.

19. The microfluidic sample device according to claim 16, further comprising:
a strut to laterally connect the first container to the second container.

20. The microfluidic sample device according to claim 6, wherein the bottom element has a thickness of at least 100 μm and less than 1.5 mm.

21. The microfluidic sample device according to claim 12, wherein the first container has a volume of at least 50 μl and less than 1500 μl.
